(19) United States
(12) Patent Application Publication
(10) Pub. No.: US 2002/0036602 A1
(43) Pub. Date: Mar. 28, 2002

(54) Method of driving a plasma display panel and apparatus thereof

(75) Inventors: Jih-Fon Huang, Hsinchu Hsien (TW); Shin-Tai Lo, Miaoli Hsien (TW)

Correspondence Address: Richard P. Berg, Esq., LADAS & PARRY, Suite 2100, 5670 Wilshire Boulevard, Los Angeles, CA, 90036-5679, US

(73) Assignee: Acer Display Technology, Inc.

(21) Appl. No.: 09/810,360

(22) Filed: Mar. 16, 2001

(30) Foreign Application Priority Data
Sep. 21, 2000 (TW) 89119450

(51) Int. Cl. G09G 3/28

(52) U.S. Cl. 345/60

(57) ABSTRACT

A PDP driving method, at the first timing point of a reset period, a global voltage difference is applied between the sustaining electrodes and the scanning electrodes, wherein the gaseous discharge occurs only in the non-display areas, called the dark areas. Because the discharge during reset period does not occur in the display areas, the picture quality is assured from avoiding the emission of over-brightness in the reset period which enables the sequential gaseous discharge operations to proceed with smaller driving voltage.

### BACKGROUND OF THE INVENTION

1. Field of the Invention

The present invention generally relates to a method of driving a plasma display panel (hereinafter referred to as PDP) and its apparatus. More specifically, the method and apparatus of the present invention can reduce the back-glow phenomena caused by the discharge operation during the reset period for a PDP, therefore, enhancing the contrast of the plasma display panel.

2. Description of the Related Art

Plasma display is one of most promising flat panel display technologies because it can provide a large and flat display screen and can display full-color images. The basic theory and operation of a PDP is described below.

FIG. 1 is a cross-sectional view of a conventional PDP cell constructed by two glass substrates 1 and 7 and the components formed thereon. Inert gases, such as Ne and Xe, are filled in the cavity between the glass substrates 1 and 7. The components formed on the glass substrate 1 include sustaining electrodes X, scanning electrodes Yi, a dielectric layer 3 and a protective film 5. The components formed on the glass substrate 7 include address electrodes Aj and the fluorescent material 9 formed thereon. The rib 8 is formed on the peripheral of each PDP cell to isolate the PDP cell. Therefore, each PDP cell 10 includes three kinds of electrodes, i.e., the sustaining electrode X and the scanning electrode Yi, which is parallel to each other, and the address electrodes Aj crossing vertically the sustaining electrode X and the scanning electrode Yi.

FIG. 2 is a block diagram illustrating a plasma display formed by the PDP cells shown in FIG. 1. As shown in the drawing, the PDP 100 is driven by the scanning electrodes Y1˜Yn, the sustaining electrodes X and the address electrodes A1˜Ap. The position of the cell 10 is as shown in the drawing. Each cell is isolated by the rib 8 as shown in FIG. 1. Furthermore, the plasma display includes the control circuit 110, the Y scanning driver 112, the X sustaining driver 114 and the address driver 116. The control circuit 110 generates timing signals for the drivers according to the external clock signal CLOCK, the data signal DATA, the vertical synchronous signal VSYNC and the horizontal synchronous signal HSYNC, wherein the clock signal CLOCK represents the data transmittal clock, the data signal DATA represents the display data, and the vertical synchronous signal VSYNC and the horizontal synchronous signal HSYNC are respectively used to define the timing sequences of a frame and a scanning line. The control circuit 110 sends the display data and the clock signal to the address driver 116 and sends the corresponding frame control clock to the Y scanning driver 112 and the sustaining driver 114. The display data is sequentially transmitted to the address driver 116 by the control circuit 110 and wall charges are built to selected cell by the address discharges. Address discharges are caused by the data pulses of address electrodes A1˜Ap and the scanning pulses of scanning electrodes Y1˜Yn which are sequentially sent by the Y scanning driver 112. The detailed operation and the control signals for the electrodes are described below.

FIG. 3 is a diagram illustrating the manner to drive a conventional PDP to display a frame. As shown in the drawing, each frame is divided into eight sub-fields SF1˜SF8. Each sub-field includes three operating period, that is, the reset period R1˜R8, the address period A1˜A8 and the sustain period S1˜S8. In the reset period, the residual charges of the former sub-field are cleared to make the initial conditions of all cells before the address period almost the same. In the address period, the address discharges are initiated in the selected cells according to the display data and then wall charges are accumulated. In the sustain period, sustain discharges for displaying are repeatedly initiated and visible light can be produced in the cells which have accumulated charges through the address discharge in the address period. All of the PDP cells are processed at the same time during the reset period R1˜R8 and the sustain period S1˜S8. The address operation is sequentially performed for each cell on the scanning electrodes Y1˜Yn during the address period A1˜A8. Moreover, the display brightness is proportional to the length of the sustain period S1˜S8. In the example of FIG. 3, the length of the sustain periods S1˜S8 of the sub-fields SF1-SF8 can be set in a ratio of 1:2:4:8:16:32:64:128 to display images in 256 gray scales.

FIG. 4 is a timing diagram of the voltage waveforms on the electrodes in a single sub-field of the prior art. The voltage waveforms on the address electrodes Aj are generated by the address driver 116, the voltage waveforms on the sustaining electrodes X are generated by the X sustaining driver 114, and the voltage waveforms on the scanning electrodes Y1˜Yn are generated by the Y scanning driver 112. As shown in the drawing, each sub-field includes the reset period, the address period and the sustain period. The voltage waveforms in each period and the resulted manners are described in detail below.

At the time point a (in FIG. 4) of the reset period, the voltage of the scanning electrodes Y1˜Yn is set to 0 V, and a write pulse having a voltage of VS+VW is applied to the sustaining electrode X, in which the voltage VS+VW is larger than the firing voltage between the sustaining electrode X and the scanning electrode Yi. Therefore, the global writing discharge W occurs between the sustaining electrode X and the scanning electrodes Yi. This discharge process accumulates negative charges on the sustaining electrode X and positive charges on the scanning electrodes Yi. The electric field produced by the accumulated negative charges and the positive charges will cancel out the voltage difference between the sustaining electrodes, thus the time of global writing discharge W is very short.

At the time point b, the sustaining electrode X is set to 0 V, and a sustaining pulse 202 having a voltage of VS is applied to all of the scanning electrodes Y1˜Yn, wherein the value of the voltage VS plus the voltage caused by the charges accumulated between the sustaining electrodes must be larger than the firing voltage between the scanning electrodes Yi and the sustaining electrode X. Thus, the global sustaining discharge S occurs between the sustaining electrode X and the scanning electrodes Yi. Different from the previous discharge process, this discharge process accumulates positive charges on the sustaining electrode X and negative charges on the scanning electrodes Yi.

At the time point c, the scanning electrode Yi is set to 0 V, an erase pulse 203 having a voltage lower than VS is applied to the sustaining electrode X, and an address pulse having a voltage of −VS can be applied to the address electrode Aj. The erase pulse is used to neutralize a part of the charges. On the scanning electrodes Y1˜Yn, required wall charges are left so that the write operation can proceed with a lower voltage in the sequential address period.

In the address period, the voltage of the sustaining electrode X and the scanning electrodes Yi are pulled up to VS at the time point d. Then a scan pulse 204 is sequentially applied to the scanning electrodes Y1˜Yn from the time point e, and an address pulse having a voltage of VA is applied to the address electrode Aj at the same time. When a cell of a scanning line turns ON, the write discharge occurs, that is, the corresponding display data is written into the cell.

After scanning all of the scanning electrodes Y1˜Yn, the sustain period begins. The sustaining electrode X and the scanning electrode Yi are first set to 0 V. Then the sustaining pulses 205 having the same voltage are applied to the sustaining electrode X and the scanning electrodes Yi in an alternate way, i.e., at the time point f and at the time point g. Thus, the cell with the data ON during the address period will irradiate. It should be noted that the waveform of driving signals described above is only an example. The waveform varies in practice, but the same theory is applied.

As described above, the length of the sustain period is proportional to the displayed brightness. Assume that a frame includes 510 sustain periods, in which each sustaining discharge period has two periods of discharge. The number of sustain periods for the sub-fields SF1˜SF8 can be 2, 4, 8, 16, 32, 64, 128, and 256, respectively. Therefore, there are 1020 periods of discharge of the sustain period during the display period of a frame. This discharge operation enables a PDP device to display images.

On the other hand, 2 to 3 discharges, such as global writing discharge, global sustaining discharge and erase discharge, are performed during the reset period to uniformly distribute the wall charges. The discharges during the reset period can also make the PDP device irradiate with a brightness brighter than that produced by the discharge during the sustain period. Roughly speaking, the brightness produced by three periods of discharge during the reset period is about the brightness by five periods of discharge during the sustain period. The ratio of the highest brightness and the lowest brightness for the PDP device is about 1020:(5×8)=26:1, in which 1 corresponds to the brightness of black. Therefore, the brightness produced by the discharge during the reset period should be as low as possible in order to improve the image quality of black, which is an important factor for displaying images. It is thus a significant issue to reduce the brightness produced by the discharge during the reset period.

### SUMMARY OF THE INVENTION

Therefore, an object of the present invention is to provide a driving method of plasma display panels, with a plurality of sustaining electrodes (X₁˜Xₘ) and a plurality of scanning electrodes (Y₁˜Yₙ) , configured in parallel and in an alternate sequence, and a plurality of address electrodes perpendicularly crossed over the sustaining electrodes and scanning electrodes; the dark areas Gⱼ are defined between the scanning electrodes Yⱼ and sustaining electrodes Xⱼ; and the display areas Dⱼ are defined between the scanning electrodes Yⱼ and sustaining electrodes Xⱼ₊₁ (n, m and j are integers, and 1≦j≦n and m). At the first timing point, applying a global writing voltage difference V_{w} between the scanning electrodes Yⱼ and sustaining electrodes Xⱼ, and there is no voltage difference between the scanning electrodes Yⱼ and sustaining electrodes Xⱼ₊₁. The global writing voltage difference V_{w} is greater than the firing voltage between the scanning electrodes Yⱼ and sustaining electrodes Xⱼ; whereby, the gas discharges are occurred between the scanning electrodes Yⱼ and sustaining electrodes Xⱼ, which generates space charges and wall charges in the dark areas Gⱼ. Because the voltage difference between the scanning electrodes Yⱼ and sustaining electrodes Xⱼ₊₁ is below the firing voltage of the gas, there is no priming discharge operation in the display areas Dⱼ.

Another object of the present invention is to provide a second driving method of plasma display panels, wherein, a plurality of sustaining electrodes (X₁˜Xₘ) and a plurality of scanning electrodes (Y₁˜Yₙ) configured in a sequence as X₁-X₂-Y₁-Y₂-X₃-X₄ . . . Xₘ₋₁-Xₘ-Yₙ₋₁-Yₙ, and a plurality of address electrodes perpendicularly crossed over the sustaining electrodes and scanning electrodes; wherein, the dark areas XGₖ are defined between the sustaining electrodes X₂ₖ₋₁ and the sustaining electrodes X₂ₖ, and the dark areas YGₖ are defined between the scanning electrodes Y₂ₖ and the scanning electrodes Y₂ₖ₋₁. And the display areas D₂ₖ₋₁, are defined between the sustaining electrodes X₂ₖ and the scanning electrodes Y₂ₖ₋₁, and the display areas D₂ₖ are defined between the scanning electrodes Y₂ₖ and the sustaining electrodes X₂ₖ₊₁ (n, m and j are integers, and 1≦j ≦n and m). Wherein, at the first timing point in the reset period, apply a global writing voltage difference V_{w} to the dark areas XGₖ and YGₖ, but there is no voltage difference in the display areas D₂ₖ₋₁ and D₂ₖ. The global writing voltage difference is greater than the firing voltage between the adjacent pairs of the sustaining electrodes X₂ₖ₋₁ and X₂ₖ, and the adjacent pairs of the scanning electrodes Y₂ₖ₋₁ and Y₂ₖ; whereby, the gas discharges are occurred in the dark areas XGₖ and YGₖ for the generation of space charges and wall charges, but do not proceed with the discharge operation in the display areas D₂ₖ₋₁ and D₂ₖ.

These and further features, aspects and advantages of the present invention, as well as the structure and operation of various embodiments thereof, will become readily apparent with reference to the following detailed description of a presently preferred, but nonetheless illustrative embodiment when read in conjunction with the accompanying drawings, in which like reference numbers indicate identical or functionally similar elements throughout the enumerated Figures.

### BRIEF DESCRIPTION OF THE DRAWINGS

The drawings referred to herein will be understood as not being drawn to scale except if specially noted, the emphasis instead being placed upon illustrating the principles of the present invention. In the accompanying drawings:

FIG. 1 represents the side view of the dissection graph of the cells in a conventional PDP;

FIG. 2 represents the block diagram of the PDP device comprised of the PDP in FIG. 1;

FIG. 3 represents the schematic diagram of the conventional PDP in a display mode;

FIG. 4 is a timing diagram of the control signals for the electrodes including the address electrodes Ai, the sustaining electrodes X and the scanning electrodes Yi in a single sub-field according to the prior art;

FIG. 5 is a schematic diagram of the sustaining electrodes and the scanning electrodes on the PDP (X-Y-X-Y) of the first embodiment of the present invention.

FIG. 6 is a timing diagram of the control signal on the sustaining electrodes and scanning electrodes in the reset period of the sub-field, according to the driving method of the first embodiment of the present invention.

FIG. 7 is a block diagram of the present invention;

FIG. 8 is a schematic diagram of the sustaining electrodes and the scanning electrodes on the PDP (XX-YY-XX-YY) of the second embodiment of the present invention;

FIG. 9 is a timing diagram of the control signal on the sustaining electrodes and scanning electrodes in the reset period of the sub-field, according to the driving method of the second embodiment of the present invention.

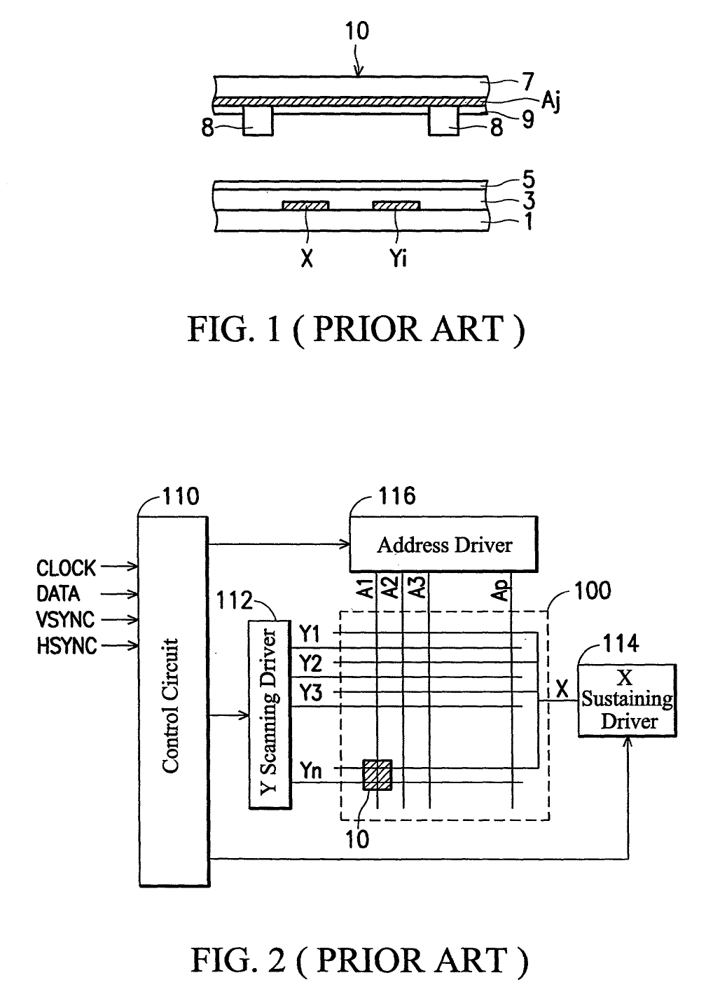

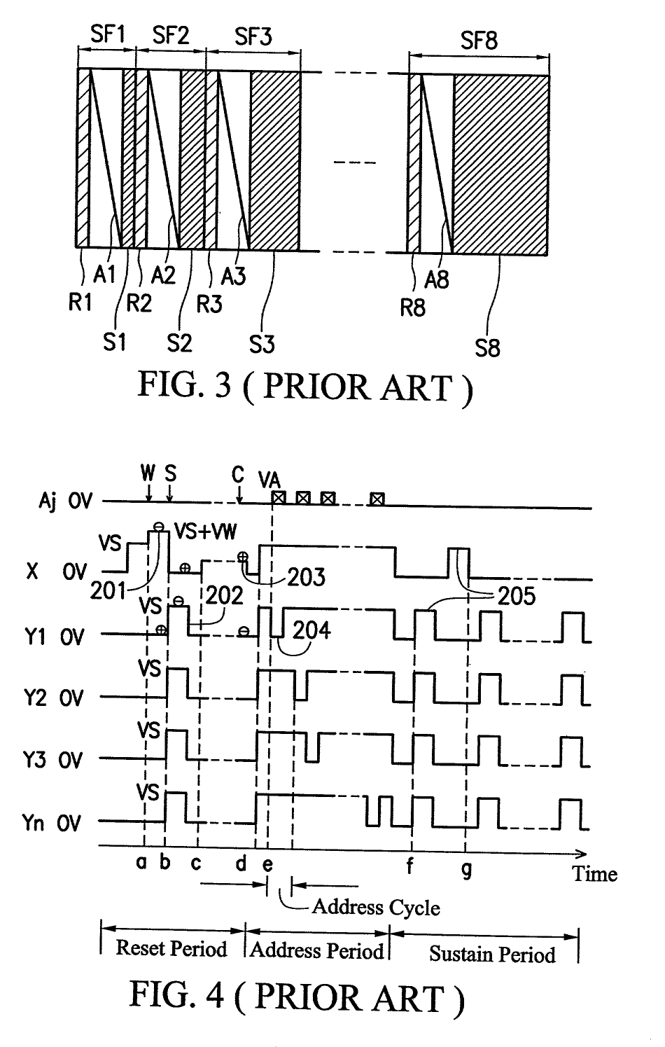

### DETAILED DESCRIPTION OF THE PREFERRED EMBODIMENTS

Reference is now made in detail to an embodiment of the present invention that illustrates the best mode presently contemplated by the inventor(s) for practicing the present invention. Other embodiments are also described herein.

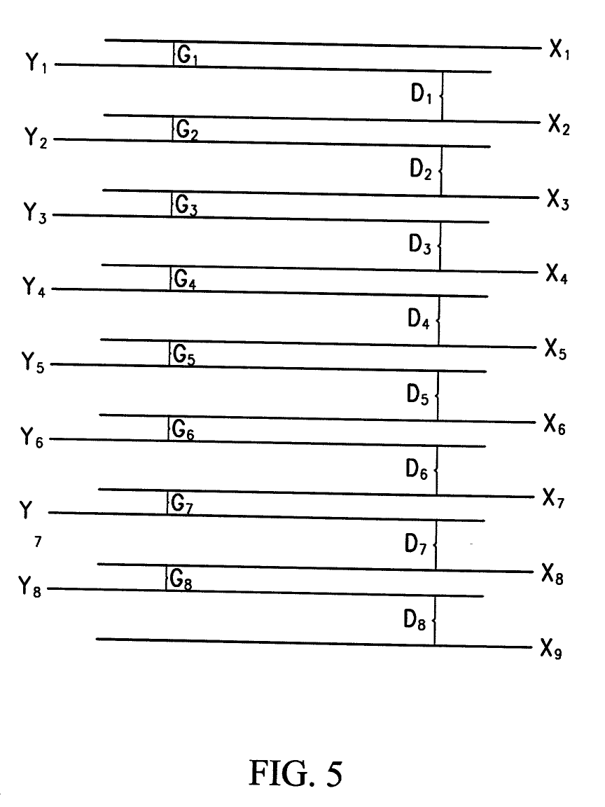

FIG. 5 is a schematic diagram of the sustaining electrodes and the scanning electrodes on the PDP of the first embodiment of the present invention. The PDP herein includes a plurality of sustaining electrodes (X₁˜Xₘ) and scanning electrodes (Y₁˜Yⱼ) configured alternately, and a plurality of address electrodes perpendicularly crossed over the sustaining electrodes and the scanning electrodes. For the purpose of illustration, the PDP in FIG. 5 has adopted the configuration of 9 sustaining electrodes (X₁˜X₉) and 8 scanning electrodes (Y₁˜Y₈) as the example. The spaces between any pairs of the scanning electrodes Yⱼ and sustaining electrodes Xⱼ are defined as the dark areas Gⱼ (j=1˜8), and that the spaces between the scanning electrodes Yⱼ and the sustaining electrodes Xⱼ₊₁ are defined as the display areas Dⱼ.

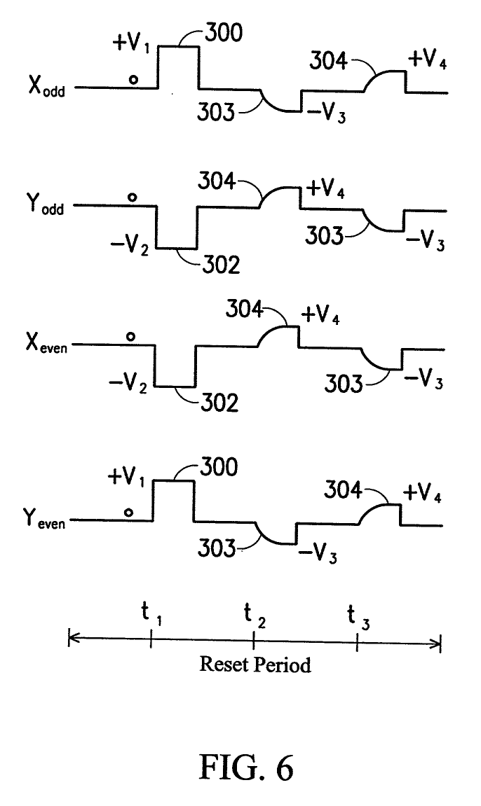

FIG. 6 is a timing diagram of the voltage waveform on each electrode (including both the odd sustaining electrodes X_{odd} and the even sustaining electrode Xₑᵥₑₙ of the sustaining electrodes X₁˜X₉ and the odd scanning electrodes Y_{odd} and the even scanning electrodes Yₑᵥₑₙ of the scanning electrodes Y₁˜Y₈) in the reset period of the sub-field, according to the driving method of the present invention. As illustrated in FIG.6, at the first timing point t₁ of the reset period, a first driving voltage pulse 300 is sent to the odd sustaining electrodes X_{odd} of the sustaining electrodes Xⱼ and the even scanning electrodes Yₑᵥₑₙ of the scanning electrodes Yⱼ , and a second driving voltage pulse 302 is sent to the odd scanning electrodes Y_{odd} of the scanning electrodes Yⱼ and the even sustaining electrodes Xₑᵥₑₙ of the sustaining electrodes Xⱼ The first driving voltage pulse 300 has a voltage of V1, and the second driving voltage pulse 302 has a voltage of −V2. As a result, a global writing voltage difference V_{w} ,(=V₁+V₂) is applied between each adjacent pair of the odd scanning electrodes Y_{odd} and the odd sustaining electrodes X_{odd} , and each adjacent pair of the even scanning electrodes Yₑᵥₑₙ and the even sustaining electrodes Xₑᵥₑₙ . But no such voltage difference is applied between each pair of adjacent odd scanning electrodes Y_{odd} and even sustaining electrodes Xₑᵥₑₙ , and each pair of adjacent even scanning electrodes Yₑᵥₑₙ and odd sustaining electrodes X_{odd} .

In the embodiment, the first driving voltage pulse 300 is +180 volts (V₁=180), and the second driving signal 302 is −180 volts (−V₂=−180). Hence, there is a global writing voltage difference V_{W} of 360 volts between each electrode pair X₁-Yₗ, X₂-Y₂, X₃-Y₃, X₄-Y₄, X₅-Y₅, X₆-Y₆, X₇-Y₇, and X₈-Y₈. Because the global writing voltage difference V_{W} is greater than the firing voltage between the scanning electrodes Yⱼ and the sustaining electrodes Xⱼ, each electrode pairs X₁-Yₗ, X₂-Y₂, X₃-Y₃, X₄-Y₄, X₅-Y₅, X₆-Y₆, X₇-Y₇, and X₈-Y₈ will start discharging in the dark areas G₁, G₂, G₃, G₄, G₅, G₆, G₇, and G₈, and then accumulate wall charges.

In addition, the voltage difference between each electrode pair Y₁-X₂, Y₂-X₃, Y₃-X₄, Y₄-X₅, Y₅-X₆, Y₆-X₇, Y₇-Y₈ and Y₈-X₉ is 0. So, no discharge operation occurs between the scanning electrodes Yⱼ and sustaining electrodes Xⱼ₊₁ in the display areas D₁ ˜D₈.

From the description. hereinbefore, it is clear that the global writing voltage difference V_{w} in the reset period makes the global writing discharge occur only between the electrode pairs X₁-Y₁, X₂-Y₂, X₃-Y₃, X₄-Y₄, X₅-Y₅, X₆-Y_{6, X}₇-Y₇, and X₈-Y₈. In other words, the global writing discharge occurred in the dark areas G₁, G₂, G₃, G₄, G₅, G₆, G₇, and G₈, but not in the display areas D₁˜D₈. Hereby, the driving method of the present invention, on one hand, the global writing discharges produce a lot of space charges, wall charges and priming particles. Owing to the priming particles produced in the dark areas can be diffused to the display areas, the firing voltage of the gas is reduced and the following gas discharges such as addressing discharges and sustaining discharge are improved. On the other hand, if a black matrix is incorporated into the dark areas G₁, G₂, G₃, G₄, G₅, G₆, G₇, and G₈, the brightness displayed during the reset period will be further reduced; hence, the contrast ratio is increased.

In order to eliminate the residual wall charges described hereof, after the first timing point t₁ (for example: the second timing point t₂), (a) send a third driving voltage pulse 303 to the odd sustaining electrodes X_{odd} and the even scanning electrodes Yₑᵥₑₙ; (b) send a forth driving voltage pulse 304 to the even sustaining electrodes Xₑᵥₑₙ and the odd scanning electrodes Y_{odd.} Hence, a first erase voltage waveform is applied on the odd sustaining electrodes X_{odd} and the even scanning electrodes Y_{even,} and a second erase voltage waveform is applied between the even sustaining electrodes Xₑᵥₑₙ and the odd scanning electrodes Y_{odd}. Similarly, the applied voltage at the second timing point t₂ only cause discharge operations at the dark areas G₁˜G₈, but not the display areas D₁ ˜D₈.

As follows, at the third timing point t₃ of the reset period, in order to fully eliminate the residual wall charges, the third and the forth driving voltage waveforms 303 and 304 are sent respectively to the sustaining electrodes and the scanning electrodes in the manner described hereinbefore.

In the present embodiment, it is assumed that V₃=V₄=90V; if V₃=0, then V₄=180V; if V₃=180V,

So, at the second timing point t₂, a first erase voltage difference V_{c1} of −180 V is applied to any of the odd electrode pairs X₁-Yₗ, X₃-Y₃, X₅-Y₅, and X₇-Y₇, and a second erase voltage difference V_{C2} is applied on any of the even electrode pairs, X₂-Y₂, X₄-Y₄, X₆-Y₆, and X₈-Y₈, to eliminate the excessive wall charges left on the bi-electric layer near the electrodes

As described, at the third timing point t₃, with the external voltage charges reversed, the first erase voltage difference V_{Cl} of 180 V and the second erase voltage difference V_{C2} of −180 V, are respectively applied to each odd electrode pairs and even electrode pairs.

The first driving signal 300 and the second driving signal 302 are respectively set as [−180 V, 180 V], [360 V, 0 V], [0 V, 360 V] and so forth, if that the voltage differences between the two are greater than the firing voltage described above.

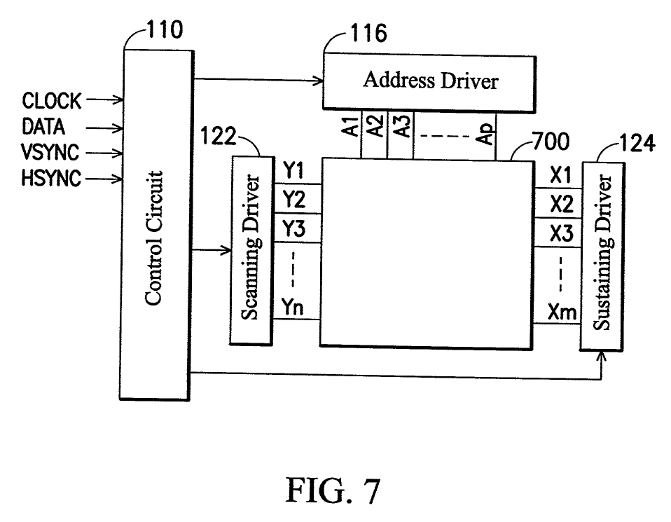

Referring to FIG. 7, a block diagram of the PDP driving device of the present invention. The driving device comprises a control circuit 110, an address driver 116, a scan driver 122, and a sustaining driver 124. The control circuit 110 receives timing signals comprises the external clock signal CLOCK, the data signal DATA, the vertical synchronous signal VSYNC and the horizontal synchronous signal HSYNC and have them distributed to each individual drivers. The address driver 116 drives the address electrodes A₁˜Aₚ and write the display data into the cells at the address period. The scan driver 122 drives the scanning electrodes Y₁ ˜Yₙ; and the sustaining driver 124 drives the sustaining electrodes X₁ ˜Xₘ. As shown in FIG. 5, 700 of the PDP is driven by the parallel scanning electrodes Y₁˜Yₙ and the sustaining electrodes X₁˜Xₘ, and the (not illustrated herein)address electrodes A₁ ˜Aₚ.

As illustrated in FIG. 6, the global writing voltage difference V_{W} at the first timing point t₁ in the reset period of each sub-field sent by the sustaining driver 124 causes the global address discharge operations to occur between each electrode pair Xⱼ˜Yⱼ in the corresponding dark areas Gⱼ, but not in the display areas Dⱼ. Consequently, the brightness displayed during the discharge operation will be effectively shielded and reduced, and still keeps a large amount of wall discharge accumulated, hence achieves high contrast of the PDP display.

As illustrated hereof, the PDP driving method of the embodiment are applied mainly in the reset period, is used to accumulate a large amount of wall discharges by applying a global voltage difference on the sustaining electrodes and the scanning electrodes in the dark areas, and not cause strong brightness during discharge operations assuring good quality of the pictures. Moreover, it only needs minor modification on part of the original driver circuit for the global writing voltage difference desired, which will not cost much and hence meet the practical demand.

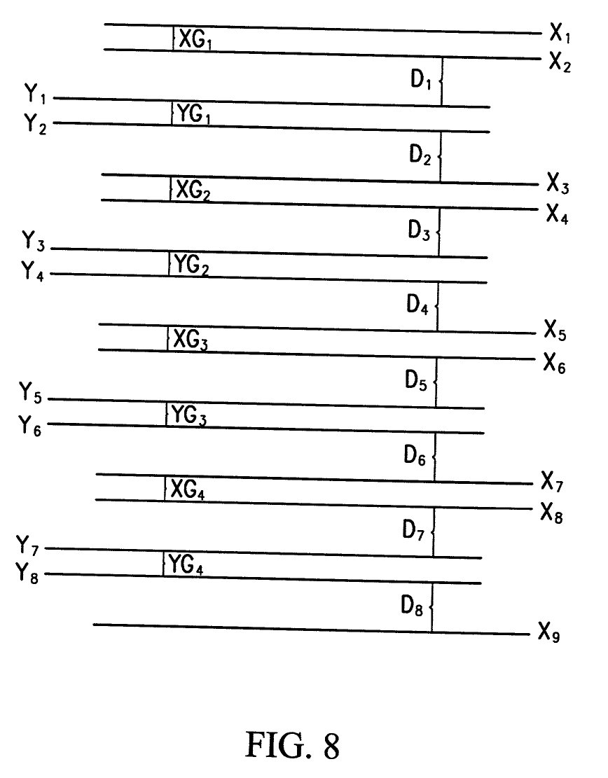

FIG. 8 is a schematic diagram of the sustaining electrodes and the scanning electrodes on the PDP of the second embodiment of the present invention. The PDP herein includes a plurality of sustaining electrodes (X₁ ˜Xₘ) and scanning electrodes (Y₁ ˜Yₙ) configured in parallel in the following manner: X₁X₂-Y₁Y₂-X₃X₄-Y₃Y₄ . . . , and a plurality of address electrodes across the sustaining electrodes and the scanning electrodes hereof. For the purpose of illustration, the PDP in FIG. 8 has adopted the configuration of 9 sustaining electrodes (X₁ ˜X₉) and 8 scanning electrodes (Y_{1˜Y}₈) as the example. The space between any of the scanning electrodes pairs described: Y₁-Y₂, Y₃-Y₄, Y₅-Y₆ and Y₇-Y₈, along with the space between the sustaining electrode pairs described: Xₗ-X₂, X₃-X₄, X₅-X₆ and X₇-X₈, are defined as the dark areas YG₁, YG2, YG₃, YG₄, XG₁, XG₂, XG₃ and XG₄. The space between the sustaining electrodes Yⱼ and Xⱼ₊₁ is defined as the display areas Dⱼ (j<8).

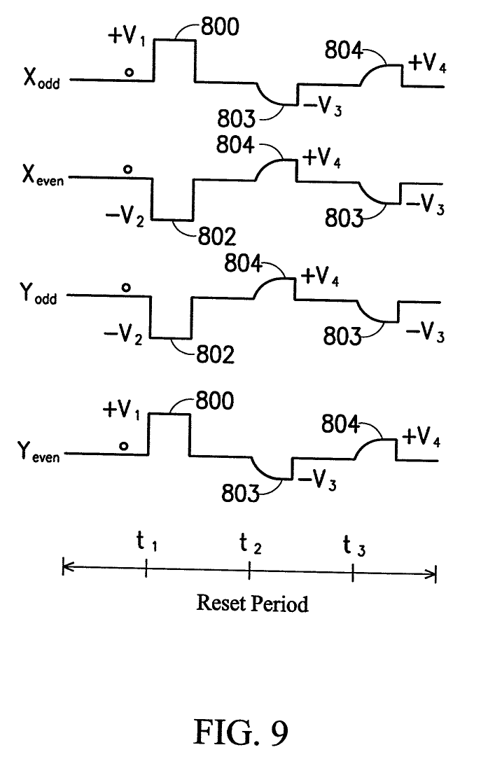

FIG. 9 is a timing diagram of the control signal on each electrode (including both the odd sustaining electrodes X_{odd} and the even sustaining electrode Xₑᵥₑₙ of the sustaining electrodes X₁˜X₉ and the odd scanning electrodes Y_{odd} and the even scanning electrodes Yₑᵥₑₙ of the scanning electrodes Y₁ ˜Y₈). in the reset period the sub-field of the embodiment of the present invention.

As illustrated in FIG.9, at the first timing point t₁ of the reset period, a first driving signal 800 is sent to the odd sustaining electrodes X_{odd} of the sustaining electrodes Xⱼ and the even scanning electrodes Yₑᵥₑₙ of the scanning electrodes Yⱼ, and a second driving signal 802 is sent to the odd scanning electrodes Y_{odd} of the scanning electrodes Yⱼ and the even sustaining electrodes Xₑᵥₑₙ to the sustaining electrodes X_{j.} As the result of the applications hereof, a global writing voltage difference V_{w}(=V₁+V₂) is applied on the sustaining electrode pairs X₁-X₂, X₃-X₄, X₅-X₆ and X₇-X₈, and scanning electrode pairs Y₁-Y₂, Y₃-Y₄, Y₅-Y₆ and Y₇-Y₈. But no such voltage difference is applied the X-Y electrode pairs X₂-Y₁, X₃-Y₂, X₄-Y₃ ,X₅-Y₄, X₆-Y₅, X₇-Y₆, X₈-Y₇ X₇-X₈, and X₉-Y₈.

In the embodiment, the first driving signal 800 is +180 volts (V₁=180), and the second driving signal 802 is 180 volts (−V₂=−180) . Hence, there is a global writing voltage difference V_{w} of 360 volts between the sustaining electrode pairs X₁-X₂, X₃-X₄, X₅-X₆ and X₇-X₈, and the scanning electrode pairs Y₁-Y₂, Y₃-Y₄, Y₅-Y₆, and Y₇-Y₈ Because the global writing voltage difference V_{W} is greater than the firing voltage between the scanning electrode pairs and the sustaining electrode pairs described above, the sustaining electrode pairs X₁-X₂, X₃-X₄, X₅-X₆, X₇-X₈ and scan electro pairs Y₁-Y₂, Y₃-Y₄, Y₅-Y₆, Y₇-Y₈ will proceed with the discharge operations in the dark areas XG₁, XG₂, XG₃, XG₄, YG₁, YG₂, YG₃, and YG₄ and accumulate wall charges.

In addition, the voltage difference between each electrode pairs X₂-Y₁, Y₂-X₃, X₄-Y₃, Y₄-X₅, X₆-Y₅, Y₆-X₇, X₈-Y₇, and Y₈-X₉ are 0. So, no discharge operation occurs in the display areas D₁˜D₈.

From the above description, it is clear that the global writing voltage difference V_{w} in the reset period results in the global writing discharge that occur only between the electrode pairs X₁-X₂, X₃-X₄, X₅-X₆, X₇-X₈ and Y₁-Y₂, Y₃-Y₄, Y₅-Y₆ Y₇-Y₈ in the dark areas XG₁, XG₂, XG₃, XG₄, YG₁, YG₂, YG₃, and YG₄, but not in the display areas D₁˜D₈. Because the dark areas XG₁ ˜YG₄ are much smaller than the display areas D₁ ˜D₈, the brightness displayed during the discharge process will be shielded and reduced immensely. Hereof, the driving method of the present invention, on one hand, keeps accumulating the large amount of charges needed, on the other hand, will not result in the over-illuminated background, hence increases the contrast. In addition, if a black matrix is incorporated into the dark areas G₁, G₂, G₃, G₄, G₅, G₆, G₇, and G₈, the displayed brightness at the reset period will be further reduced.

Moreover, the sustaining electrodes and the scanning electrodes can be rearranged to further decrease the area ratio between the dark areas and the display areas ,which produces better PDP resolvability and further reduces the display brightness in the reset period.

In order to eliminate the residual wall charges described hereof, after the first timing point t₁(for example: the second timing point t₂), (a)send a third driving signal 803 to the odd sustaining electrodes X_{odd} and the even scanning electrodes Yₑᵥₑₙ; (b)send a forth driving signal 804 to the even sustaining electrodes Xₑᵥₑₙ and the odd scanning electrodes Y_{odd}. Hence, a first erase voltage difference V_{c1} (=−V₃−V₄) is applied on the odd sustaining electrodes X_{odd} and the even sustaining electrodes Xₑᵥₑₙ, and a second erase signal V_{c2} (=V₄+V₃) is applied between the even scanning electrodes Yₑᵥₑₙ and the odd scanning electrodes Y_{odd}. Similarly, the applied voltages at the second timing point t₂ only cause discharge operations at the dark areas XG₁˜XG₄ and YG₁ ˜YG₄ but not the display areas D₁˜D₈.

As follows, at the third timing point t₃ of the reset period, in order to eliminate the residual wall charges the third and the forth driving signals 303 and 304, with the charges opposite from those at the second timing point t₂, are sent to proceed the reverse discharges.

It is assumed that the third driving signal 803 is OV (as that of 303 in FIG.6), and the fourth driving signal 804 is +180 V.

So, at the second timing point t₂, a first erase voltage difference V_{cl} of −180V is applied to any of the odd electrode pairs X₁-Yₗ,, X₃-Y₃, X₅-Y₅, and X₇-Y₇, and a second erase voltage difference V_{c2} is applied on any of the even electrode pairs, X₂-Y₂, X₄-Y₄, X₆-Y₆, and X₈-Y₈, to eliminate the excessive wall charges left on the bi-electric layer near the electrodes.

At the third timing point t₃, with the external voltage charges reversed, the first erase voltage difference V_{c1} of 180 V and the second erase voltage difference V_{c2} of −180V, are respectively applied to each sustaining electrode pairs and scanning electrode pairs.

The first driving signal 800 and the second driving signal 802 are respectively set as [−180V, 180 V], (360 V, 0 V], [0 V, 360 V] and so forth, if that the voltage differences between the two are greater than the firing voltage described above.

The block diagram of the PDP driving device of the embodiment is similar to that shown in FIG. 7. Referring to FIG. 7, the driving device comprises a control circuit 110, an address driver 116, a scan driver 122, and a sustaining driver 124. The control circuit 110 receives timing signals comprises the external clock signal CLOCK, the data signal DATA, the vertical synchronous signal VSYNC and the horizontal synchronous signal HSYNC and have them distributed to each individual drivers. The address driver 116 drives the address electrodes A₁˜Aₚ and writes the display data into the cells at the address period. The scan driver 122 drives the scanning electrodes Y₁˜Yₙ; and the sustaining driver 124 drives the sustaining electrodes X₁˜Xₘ. As shown in FIG.5, 700 of the PDP is driven by the parallel scanning electrodes Y₁˜Yₙ and the sustaining electrodes X₁ ˜Xₘ, and the (not illustrated herein)address electrodes A₁˜Aₚ.

As illustrated in FIG. 6, the global writing voltage difference V_{W} at the first timing point t₁, in the reset period of each sub-field sent by the sustaining driver 124 causes the global address discharge operations to occur between each of the electrode pairs X₁-X₂ ˜X₇-X₈ and Y₁-Y₂˜Y₇-Y₈ in the corresponding dark areas XG₁ - XG₄ and YG₁ - YG₄, but not in the display areas D₁ - D₈. Consequently, the brightness displayed during the discharge operation will be effectively shielded and reduced, and still will keep a large quantity of accumulated wall discharge, hence achieving the desired high contrast of the PDP display.

As illustrated hereof, the PDP driving method of the embodiment are applied mainly in the reset period, is used to accumulate a large amount of wall discharge by applying a global voltage difference on the sustaining electrodes and the scanning electrodes in the dark areas, and not cause strong brightness during the discharge operation assuring the good quality of the pictures. Moreover, it only needs minor modifications on part of the original driver circuit to generate the global writing voltage difference desired, which does not cost much and hence meet the practical demand.

While the invention has been described by way of example and in terms of the preferred embodiment, it is to be understood that the invention is not limited to the disclosed embodiments. On the contrary, it is intended to cover various modifications and similar arrangements as would be apparent to those skilled in the art. Similarly, any process steps described herein may be interchangeable with other steps in order to achieve the same result. Therefore, the scope of the appended claims should be accorded the broadest interpretation so as to encompass all such modifications and similar arrangements, which is defined by the following claims and their equivalents.

What is claimed is:

1. A PDP driving method, with a plurality of sustaining electrodes (X₁ ˜Xₘ) and a plurality of scanning electrodes (Y₁ ˜Yₙ), configured in an alternate sequence as X₁-Yₗ-X₂-Y₂-X₃-Y₃ . . . Xₘ-Yₙ on said PDP, and a plurality of address electrodes cross over said sustaining electrodes and scanning electrodes; according to the arranging sequence, said sustaining electrodes (X₁ ˜Xₘ) are divided into the odd sustaining electrodes X_{odd} and the even sustaining electrodes Xₑᵥₑₙ, said scanning electrodes (Y₁ ˜Yₙ) are divided into the odd scanning electrodes Y_{odd} and the even scanning electrodes Yₑᵥₑₙ; dark areas Gⱼ are located between said odd scanning electrodes Y_{odd} and said odd sustaining electrodes X_{odd}, and said even scanning electrodes Yₑᵥₑₙ and said even sustaining electrodes Xₑᵥₑₙ, in which no display data is written, and display areas Dⱼ, written with display data, are located between said odd scanning electrodes Y_{odd} and said even sustaining electrodes Xₑᵥₑₙ, and between said even scanning electrodes Yₑᵥₑₙ and said odd sustaining electrodes X_{odd}, wherein, n, m and j are integers, and 1≦j ≦n and m; when the voltage difference between adjacent said sustaining electrodes (X₁ ˜Xₘ) and said scanning electrode (Y₁ ˜Yₙ) is greater than a firing voltage, said adjacent sustaining electrodes (X₁ ˜Xₘ) and scanning electrodes (Y₁ ˜Yₙ) will start a discharge operation, said driving method comprising the following steps:
(a) at the first timing point in the reset period, applying a global writing voltage difference V_{W} between said adjacent pairs of said odd scanning electrodes Y_{odd} and odd sustaining electrodes X_{odd}, and said adjacent pairs of said even scanning electrodes Yₑᵥₑₙ and even sustaining electrodes Xₑᵥₑₙ, wherein said global writing voltage difference is greater than said firing voltage; and
(b) at said first timing point in the reset period, applying a second voltage difference between said adjacent odd scanning electrodes Y_{odd} and even sustaining electrodes Xₑᵥₑₙ, and each pair of adjacent even scanning electrodes Yₑᵥₑₙ and odd sustaining electrodes X_{odd};
wherein the priming discharge of reset occurs only in said dark areas Gⱼ.

2. The driving method as claimed in claim 1, wherein a first driving signal is sent to said odd sustaining electrodes X_{odd} and said even scanning electrodes Yₑᵥₑₙ, and a second driving signal is sent to said odd scanning electrodes Y_{odd} and said even sustaining electrodes X_{even.}, and said first driving signal and said second driving signal are added to form a global writing difference, whereby, (1) applying said global writing voltage between said odd scanning electrodes Y_{odd} and said odd sustaining electrodes X_{odd}, and said even scanning electrodes Yₑᵥₑₙ and said even sustaining electrodes Xₑᵥₑₙ, and (2) there is no voltage difference between said odd scanning electrodes Y_{odd} and said odd sustaining electrodes X_{odd}, and said even scanning electrodes Yₑᵥₑₙ and the even sustaining electrodes Xₑᵥₑₙ, thus the priming discharge of reset not occurring in said display areas Dⱼ.

3. The driving method as claimed in claim 2, wherein said first driving signal and said second driving signal carry the reverse charges.

4. The driving method as claimed in claim 2, wherein at least the voltage of one of said first driving signal and said second driving signal is zero.

5. The driving method as claimed in claim 1, the driving method further comprises the following steps:
(c) at the second timing point following said first timing point in the reset period, applying a first erase voltage difference between said odd scanning electrodes Y_{odd} and said odd sustaining electrodes X_{odd}, and said even scanning electrodes Yₑᵥₑₙ and said even sustaining electrodes Xₑᵥₑₙ.

6. The driving method as claimed in claim 5, the driving method further comprises the following steps:
(d) at the third timing point following said second timing point in the reset period, applying a second erase voltage difference between said odd scanning electrodes Y_{odd} and said odd sustaining electrodes X_{odd}, and said even scanning electrodes Yₑᵥₑₙ and said even sustaining electrodes Xₑᵥₑₙ, whereas said first erase voltage and said second erase voltage carry reverse charges.

7. The driving method as claimed in claim 6, wherein said first erase voltage difference is resulted from the incorporated effect that a third driving signal sent to said odd sustaining electrodes X_{odd} and said even scanning electrodes Yₑᵥₑₙ, and a fourth driving signal sent to said even sustaining electrodes Xₑᵥₑₙ and said odd scanning electrodes Y_{odd}.

8. The driving method as claimed in claim 6, wherein said second erase voltage difference results from the incorporated effect that said fourth driving signal sent to said odd sustaining electrodes X_{odd} and said even scanning electrodes Yₑᵥₑₙ, and said fourth driving signal sent to said even sustaining electrodes Xₑᵥₑₙ and said odd scanning electrodes Y_{odd}, whereas, said first voltage difference is equal to said second voltage difference in magnitude, but with the opposite electric charge.

9. The driving method as claimed in claim 7, wherein said third driving signal has the reverse charge with said fourth driving signal.

10. The driving method as claimed in claim 7, wherein at least one of said third driving signal and said fourth signal is zero.

11. A PDP driving method, with a plurality of sustaining electrodes (X₁ ˜Xₘ) and a plurality of scanning electrodes (Y₁ ˜Yₙ) , configured in a sequence as X₁-X₂-Y_{1-Y}₂-X₃-X₄ . . . Xₘ₋₁-Xₘ-Yₙ₋₁-Yₙ, and a plurality of address electrodes cross over said sustaining electrodes and said scanning electrodes, are located on said PDP; said scanning electrodes (Y₁ ˜Yₙ) are divided into the odd scanning electrodes Y_{odd} and the even scanning electrodes Yₑᵥₑₙ; dark areas Gⱼ, are defined between every two adjacent sustaining electrodes of said odd sustaining electrodes X_{odd} and said even sustaining electrodes X_{odd}, and every two adjacent scanning electrodes of said odd scanning electrodes Y_{odd} and said even scanning electrodes Yₑᵥₑₙ, in which no display data is written, and display areas Dⱼ, written with display data, are defined between every two adjacent electrodes of said odd scanning electrodes Y_{odd} and said even sustaining electrodes Xₑᵥₑₙ, and between every two adjacent electrodes of said even scanning electrodes Yₑᵥₑₙ and said odd sustaining electrodes X_{odd}, wherein, n, m and j are integers, and 1≦j ≦n and m; when the voltage difference between adjacent said sustaining electrodes (X₁˜Xₘ) and said scanning electrodes (Y₁˜Yₙ) is greater than a firing voltage, said adjacent sustaining electrodes (X₁˜Xₘ) and scanning electrodes (Y₁˜Yₙ) will start a discharge operation, the driving method comprising the following steps:
(a) at the first timing point in the reset period, applying a global writing voltage difference V_{w} between said adjacent pairs of said even sustaining electrodes Xₑᵥₑₙ and odd sustaining electrodes X_{odd}, and said adjacent pairs of said even scanning electrodes Yₑᵥₑₙ and odd scanning electrodes Y_{odd}, whereas said global writing voltage difference is greater than said firing voltage; and
(b) at said first timing point in the reset period, adjusting the voltage difference between said adjacent odd scanning electrodes Y_{odd} and even sustaining electrodes Xₑᵥₑₙ, and each pair of adjacent even scanning electrodes Yₑᵥₑₙ and odd sustaining electrodes X_{odd};
Wherein the priming discharge occurs only in said dark areas Gⱼ.

12. The driving method as claimed in claim 11, wherein a first driving signal is sent to said odd sustaining electrodes X_{odd} and said even scanning electrodes Yₑᵥₑₙ, and a second driving signal is sent to said odd scanning electrodes Y_{odd} and said even sustaining electrodes X_{even.}, and said first driving signal and said second driving signal are added to form a global writing difference, whereby, (1) applying said global writing voltage between said odd sustaining electrodes X_{odd} and said even sustaining electrodes Xₑᵥₑₙ, and said even scanning electrodes Yₑᵥₑₙ and said odd scanning electrodes Yₑᵥₑₙ, and (2) no voltage difference between said odd scanning electrodes Y_{odd} and said even sustaining electrodes Xₑᵥₑₙ, and said even scanning electrodes Yₑᵥₑₙ and the odd sustaining electrodes X_{odd}, thus the priming discharge of reset not occurring in said display areas Dⱼ.

13. The driving method as claimed in claim 11, the driving method further comprising the step of:
(c) at the second timing point following said first timing point in the reset period, applying a first erase voltage difference between said odd sustaining electrodes X_{odd} and said even sustaining electrodes Xₑᵥₑₙ, and said even scanning electrodes Yₑᵥₑₙ and said odd scanning electrodes Y_{odd}.

14. The driving method as claimed in claim 13, the driving method further comprises the step of:
(d) at the third timing point following said second timing point in the reset period, applying a second erase voltage difference between said odd sustaining electrodes X_{odd} and said even sustaining electrodes Xeven, and said even scanning electrodes Yₑᵥₑₙ and said odd scanning electrodes Yₑᵥₑₙ, whereas said first erase voltage and said second erase voltage carry reverse charges.
